(19) United States
(12) Patent Application Publication
(10) Pub. No.: US 2024/0010236 A1
(43) Pub. Date: Jan. 11, 2024

(54) Selection of Driving Maneuvers for at Least Semi-Autonomously Driving Vehicles

(71) Applicant: Robert Bosch GmbH, Stuttgart (DE)

(72) Inventors: Felix Schmitt, Ludwigsburg (DE); Martin Stoll, Renningen (DE); Johannes Goth, Wildberg (DE); Holger Andreas Banzhaf, Laichingen (DE); Johannes Maximilian Doellinger, Esslingen Am Neckar (DE); Michael Hanselmann, Korntal-Muenchingen (DE)

(21) Appl. No.: 18/255,849

(22) PCT Filed: Nov. 30, 2021
(86) PCT No.: PCT/EP2021/083637

§ 371 Date: Jun. 2, 2023

(30) Foreign Application Priority Data
Dec. 3, 2020 (DE) 10 2020 215 324.8

(51) Int. Cl. B60W 60/00; G06N 7/01

(52) U.S. Cl. CPC B60W 60/0015; G06N 7/01; B60W 2555/60; B60W 30/18163

(57) ABSTRACT

A method for selecting a driving maneuver to be carried out by an at least semi-autonomously driving vehicle is disclosed. The method includes (i) using measurement data of at least one sensor carried by the vehicle, creating a representation of the situation the vehicle is in, (ii) mapping the representation of the situation to a probability distribution by way of a trained machine learning model, which probability distribution specifies a probability for every driving maneuver from a predefined catalog of available driving maneuvers, with which said driving maneuver is carried out, (iii) selecting a driving maneuver from the probability distribution as the driving maneuver to be carried out, (iv) in addition to using at least one aspect of the situation the vehicle is in, a subset of driving maneuvers which are disallowed in this situation is determined, and (v) this disallowed driving maneuver is prevented from being carried out.

### PRIOR ART

An at least semi-autonomously driving vehicle continually senses the situation which it in to adjust the planning of driving maneuvers in regard to near-term changes in this situation. For example, changes in the situation the vehicle needs to respond to can be due to the vehicle moving to a different location with different conditions. However, movements of other objects, such as other road users, can change the situation significantly and require a reaction. DE 10 2018 210 280 A1 discloses a method by which the trajectories of foreign objects can be forecasted so that the trajectory of the ego vehicle can be adjusted accordingly.

Some methods for planning driving maneuvers create a representation of the situation which the vehicle is in and map that representation to a probability distribution using a trained machine learning model that specifies probabilities for the essentially available driving maneuvers. Based on this probability distribution, a driving maneuver is selected as the driving maneuver to be carried out, and the actuating means of the vehicle are controlled accordingly.

### DISCLOSURE OF THE INVENTION

In the context of the invention, a method has been developed for selecting a driving maneuver to be carried out by an at least semi-autonomously driving vehicle. The method begins with using measurement data from at least one sensor carried by the vehicle to create a representation of the situation the vehicle is in. This representation of the situation is mapped to a probability distribution by a trained machine learning model. The representation can in particular be, e.g., a summary representation of the situation created in any form and manner.

The measurement data can in particular include, e.g., image data, video data, radar data, LIDAR data, and/or ultrasonic data.

A machine learning model is in particular understood to mean a model which embodies a parameterized function that includes adjustable parameters and has generalization performance. These parameters can be adjusted during the training of a machine learning model, in particular such that, when entering learning representations into the model, the previously known target outputs associated with the learning inputs are reproduced as well as possible. The machine learning model can in particular include an artificial neural network (ANN), and/or it can be an ANN.

The probability distribution specifies a probability for every driving maneuver from a predefined catalog of available driving maneuvers with which said driving maneuver is carried out. Based on the probability distribution, a driving maneuver is selected as the driving maneuver to be carried out.

In addition to using at least one aspect of the situation the vehicle is in, a subset of driving maneuvers which are disallowed in this situation is determined. These disallowed driving maneuvers are prevented from being carried out.

Training the machine learning model is oriented toward separating the more appropriate driving maneuvers for the given situation from the less appropriate driving maneuvers. Disallowed driving maneuvers are therefore evaluated to a large extent by the machine learning model as being less appropriate. Selecting the driving maneuver ultimately carried out from the probability distribution, in comparison to a direct mapping of the representation to exactly one driving maneuver by the machine learning model, leads to a more realistic and, in particular, less surprising driving behavior for other road users. However, it cannot be avoided that disallowed driving maneuvers in the probability distribution will also be assigned a non-zero probability. This means that the disallowed driving maneuver is actually selected and executed at a certain level of probability. This probability can be greater than the acceptable residual risk specified for autonomous driving operation.

Further, boundary conditions that render a specific driving maneuver to be disallowed in a particular situation can be comparatively complex and/or such that it is inappropriate to include them in the training of the machine learning model. The strength of the machine learning model lies in the power to generalize, based on a limited number of training situations, to an indefinite plurality of situations. However, if for example, fixed conditions for autonomous travel operations dictate that certain driving maneuvers are only to be carried out within certain speed ranges or that an overtaking maneuver can only be initiated at a prescribed minimum distance from oncoming traffic, the aforementioned generalization performance is not the ideal tool. Instead, it is more advantageous to automatically enforce such boundary conditions via the machine learning model.

The prevention of disallowed driving maneuvers can in particular be carried out entirely independently of the machine learning model. In other words, the machine learning model can initially be trained apart from the allowability of individual driving maneuvers, which are only implemented after the fact. As a result, even subsequent changes to the requirements with respect to allowability will no longer affect the training of the machine learning model. Such changes can then be implemented in a variety of ways without needing to repeat all or part of the training. Training adjustment typically requires the completion of test drives, which include representations of certain new situations. These representations must then be manually labelled with the driving maneuvers desired in the respective situations.

This effort is not necessary in order to adjust, e.g., the speed range within which a driving maneuver is allowed. New regulations, e.g., permitting use of the paved shoulder as a traffic lane on particularly highly traveled highway sections can also be implemented in a simplified manner by declaring the lane change to the paved shoulder (which would normally be rejected as disallowed) as allowable if correspondingly released.

In a particularly advantageous embodiment, at least one disallowed driving maneuver is prevented from being carried out by setting the probability of this driving maneuver being carried out to zero in the probability distribution. A modified probability distribution is generated thereby. In this way, it is ensured that only an allowable driving maneuver can be selected when selecting from the probability distribution and that the selection does not remain entirely without a useful result. No separate “error handling” is then necessary in the event that a disallowed driving maneuver is selected.

For example, the probability distribution can in particular, after being set to zero, be normalized so that the remaining non-zero probabilities for driving maneuvers add up to 1. A modified probability distribution is also generated in this case. A driving maneuver that is dismissed as disallowed then loses its previous probability of being selected and distributes it pro rata among the driving maneuvers that are remaining as allowed. This is quite similar to a situation in which the failure of one of several applicants applying for an apartment or a job causes the previous chances to the remaining applicants to be redistributed by way of a no-go criterium: The failure of the one applicant does not change the fact that the apartment or job will certainly be filled (Probability 1).

Alternatively, or also in combination with a subsequent change in the probability distribution, the performance of at least one disallowed driving maneuver can be prevented by selecting a new driving maneuver from the probability distribution in response to this driving maneuver having been selected from the probability distribution. Because the probability distribution allocates higher probabilities to the allowable driving maneuvers, it is expected, but not guaranteed, that an allowable driving maneuver will be selected upon reselection. If necessary, reselection must be repeated until an allowable driving maneuver is obtained as a result.

The advantage of repeated selection is that situations in which a disallowed driving maneuver was first selected can be detected and evaluated. When such situations accumulate, this can be an indicator that the machine learning model is no longer accurately sensing the situation, and its training needs to be adjusted accordingly. One possible cause of this can be the introduction of new road traffic rules following the training of the machine learning model.

For example, the newly introduced traffic sign for environmental zones was largely modeled on the traffic sign announcing the start of a 30 km/hr speed limit zone. But the number “30” within the red circle was replaced by the word “environment.” This recognition value well desired by human drivers can become a problem if the machine learning model only knows the “30 km/hr speed limit zone” sign. If, for example, a highway permitting 80 km/hr leads into an environmental zone, the machine learning model might detect a speed restriction to 30 km/hr and recommend correspondingly abrupt braking as the most appropriate driving maneuver. If such abrupt braking exceeds the maximum delay permitted for autonomous travel operation, the braking is disregarded as disallowed and is not carried out. If it is then detected that the same driving maneuver at the same location was repeatedly rejected as disallowed during driving operation, then the vehicle user receives feedback that something is fundamentally wrong and the machine learning model requires an update.

In a further particularly advantageous embodiment, at least one disallowed driving maneuver is determined based on information retrieved from a digital location-resolved map based on the current position of the vehicle. The digital map can, in particular, record road travel, the number of lanes available per direction of travel, speed restrictions, overtaking prohibitions, and other traffic rules. For example, if it turns out that no additional traffic lane, or no navigable portion whatsoever exists to the left or right of the current lane according to the map, then a lane change to the left or to the right can be evaluated as being disallowed.

A disallowed driving maneuver can then in particular include, e.g., a driving maneuver that presents a risk of
departing the roadway, and/or
violating general traffic rules, and/or
violating special conditions for autonomous driving operation, and/or
the ego vehicle colliding with another vehicle or other object.

In particular, the disallowed driving maneuvers can include, e.g.:
a lane change leading to departing the roadway, and/or
a lane change to a currently inaccessible lane, and/or
an acceleration and/or overtaking maneuver prohibited by traffic rules; and/or
driving behind another vehicle that is currently located behind the ego vehicle.

As previously explained, filtering out impermissible driving maneuvers can take place independent of the machine learning model, which initially has complete freedom to suggest any driving maneuver that is generally available. However, the knowledge of which driving maneuvers are disallowed can also be incorporated into the training of the machine learning model in a bracketing manner for this purpose.

Therefore, the invention also relates to a method for training a machine learning model. This machine learning model maps a representation of a situation a vehicle is in to a probability distribution that specifies a probability for every driving maneuver from a predefined catalog of available driving maneuvers with which said driving maneuver is carried out.

As part of this method, learning representations of situations and associated target probability distributions, to which the machine learning model is intended to map these learning representations, are provided. The learning representations are entered into the machine learning model and mapped from the machine learning model to probability distributions. The agreement between these probability distributions and the respective target probability distributions is evaluated using a predefined cost function. Parameters that characterize the behavior of the machine learning model are optimized with the goal of further processing of learning representations resulting in better evaluation by the cost function.

Regarding at least one driving maneuver disallowed in the situation characterized by the learning representation, the possibility that an increase in the probability assigned to this driving maneuver will lead to a better evaluation by the cost function is prevented.

This means that the machine learning model cannot gain an advantage with respect to the evaluation by the cost function by proposing a disallowed driving maneuver. In order to improve with respect to this evaluation, the machine learning model therefore needs to consider increasing the probabilities of other driving maneuvers. This does not exclude impermissible driving maneuvers in the probability distribution still being assigned a non-zero probability. However, it is clearly preferred that only the probabilities for permitted driving maneuvers will be increased.

In one advantageous embodiment, the cost function is extended by a penalty term that depletes and/or overcompensates for an advantage that an increase in the probability assigned to the disallowed driving maneuver would achieve with respect to the original cost function. As is similar to criminal law, in which even very serious crimes cannot entirely be prevented by the threat of prosecution, it is then not ruled out that disallowed driving maneuvers will, as before, be assigned non-zero probabilities. However, a strong incentive is created to only increase the probabilities for allowed driving maneuvers instead.

Alternatively or in combination, a probability provided by the machine learning model and assigned to the disallowed driving maneuver can be set to zero by the cost function prior to being evaluated. Increasing this probability is not explicitly punished thereby, but it no longer has an effect on the optimization process. During the course of training, the machine learning model will learn that changes to the probabilities for disallowed driving maneuvers will no longer have an effect on optimizing the cost function. Corresponding attempts are then abandoned in favor of optimizing the probabilities for allowed driving maneuvers. This procedure is somewhat comparable to a “time-out chair” for a child who seeks to gain attention by temperamental tantrums being brought to reason by withholding this same attention.

In a further advantageous embodiment, the probability distribution is regularized and/or discretized so that probabilities below a predefined threshold value are suppressed to zero. As a result, a guarantee could be provided that the selection from the probability distribution will not produce any disallowed driving maneuver. For example, an L1 norm can be used for this purpose.

The methods can, in particular, be implemented on one or more computers, for example, and can be embodied in software in this respect. The invention therefore also relates to a computer program including machine-readable instructions which, when they are executed on one or more computers, prompt the computer(s) to carry out one of the described methods.

Likewise, the invention also relates to a machine-readable data storage medium and/or to a download product including the computer program. A download product is a digital product that can be transmitted via a data network, i.e., can be downloaded by a user of the data network, and can, e.g., be offered for sale in an online shop for immediate download.

Furthermore, a computer can be equipped with the computer program, with the machine-readable storage medium, or with the download product.

Further measures for improving the invention are described in greater detail hereinafter in reference to the drawings, together with the description of the preferred exemplary embodiments of the invention.

### EXEMPLARY EMBODIMENTS

Shown are:

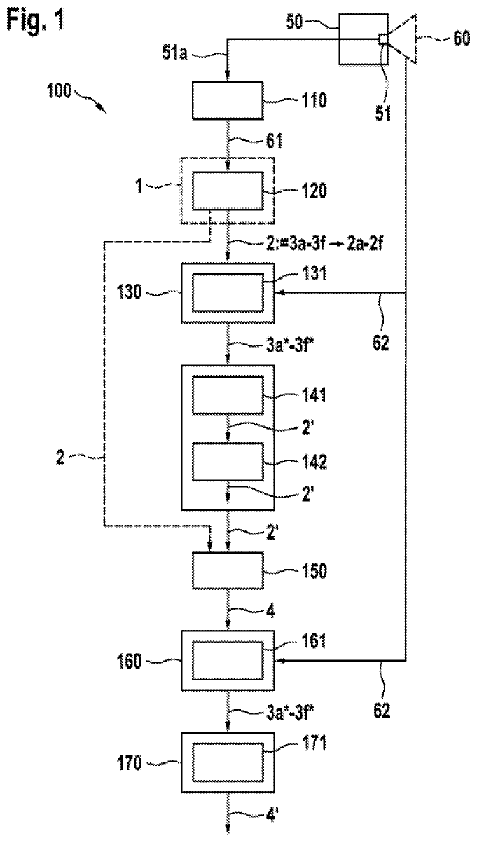

FIG. 1 an exemplary embodiment of the method 100 for selecting a driving maneuver 4;

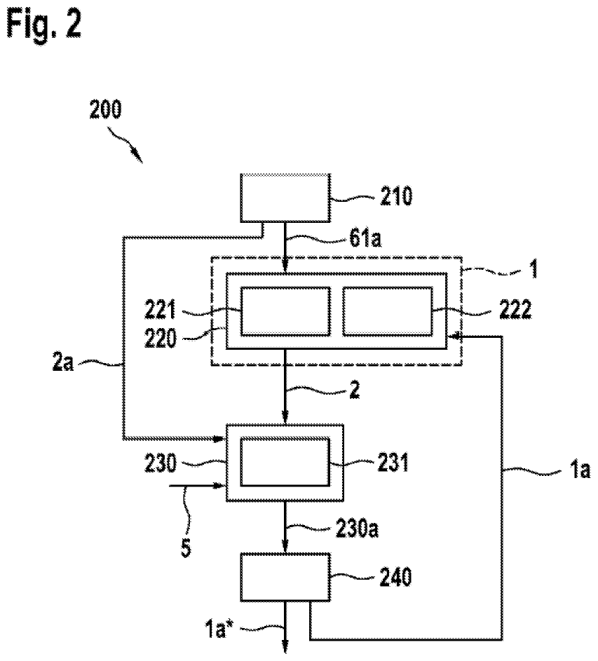

FIG. 2 an exemplary embodiment of the method 200 for training a machine learning model 1.

FIG. 1 shows a flow chart of an exemplary embodiment of the method 100. The goal of method 100 is to select a driving maneuver 4 which is to be carried out and is appropriate to the current situation 60 of vehicle 50 from a predefined catalog of driving maneuvers 3a-3f.

For this purpose, in step 110, using measurement data 51a of at least one sensor 51 carried by the vehicle, a representation 61 is created of the situation 60 the vehicle 50 is in. This representation 61 of the situation 60 is mapped to a probability distribution 2 in step 120 by a trained machine learning model 1. The probability distribution 2 specifies a probability 2a-2f for every driving maneuver 3a-3f from the predefined catalog of available driving maneuvers 3a-3) with which said driving maneuver 3a-3f is carried out.

At this point, a subset of disallowed driving maneuvers 3a*-3f* for the situation 60 can already be determined in step 130 by using at least one aspect 62 of the situation 60. Subsequently, in step 140, these disallowed driving maneuvers 3a*-3f* can be prevented from being carried out. For this purpose, in particular according to block 141 in the probability distribution 2, the probability 2a-2f that the disallowed driving maneuver 3a*-3f* is carried out can be set to zero. After this zeroing, according to block 142, the probability distribution can be normalized such that the remaining non-zero probabilities 2a-2f for driving maneuvers 3a-3f add up to 1. A modified probability distribution 2′ then results.

In step 150, a driving maneuver 3a-3f is selected as the driving maneuver 4 to be carried out from the modified probability distribution 2′ or from the original probability distribution 2.

Intervention can be made to filter out disallowed driving maneuvers 3a*-3f* at this point as well. For this purpose, in step 160, like in step 130, the disallowed driving maneuvers 3a*-3f* can be determined using at least one aspect 62 of the situation 60. These disallowed driving maneuvers 3a*-3f* can then be prevented in step 170. For example, in particular in response to a disallowed driving maneuver 3a*-3f* being selected from the probability distribution 2, a new driving maneuver 3a-3f can be selected from the probability distribution 2 for this purpose. As a result, the originally selected driving maneuver 4 then no longer exists, but rather the newly selected driving maneuver 4′.

In particular, the disallowed driving maneuvers 3a*-3f* can be determined, e.g., according to blocks 131 and 161, respectively, based on information retrieved from a digital location-resolved map based on the current position of the vehicle 50.

FIG. 2 is a schematic flow chart of an exemplary embodiment of the method 200 for training the machine learning model 1. The machine learning model 1 maps a representation 61 of a situation 60 a vehicle 50 is in to a probability distribution 2. This probability distribution 2 specifies a probability 2a-2f for each driving maneuver 3a-3f from a predefined catalog of available driving maneuvers 3a-3f with which said driving maneuver 3a-3f is be carried out.

In step 210, learning representations 61a of situations 60 and associated target probability distributions 2a to which the machine learning model 1 is to map these learning representations 61a are provided. In step 220, the learning representations 61a are entered into the machine learning model 1 and mapped from the machine learning model 1 to probability distributions 2. In step 230, the agreement between these probability distributions 2 and the respective target probability distributions 2a is evaluated using a predefined cost function 5. In step 240, parameters 1a that characterize the behavior of the machine learning model (1) are optimized. The goal of this optimization is to further process learning representations 61a, thus leading to a better evaluation 230a by the cost function 5. The fully trained state of the parameters 1a is designated by reference sign 1a*.

In this context, for at least one driving maneuver 3a*-3f* disallowed in the situation 60 characterized by the learning representation 61a, the possibility that an increase in the probability 2a-2f assigned to this driving maneuver 3a*-3f* will lead to a better evaluation 230a by the cost function 5 is prevented. By way of example, FIG. 2 shows ways in which this can be achieved.

For example, according to block 231, cost function 5 can be extended by a penalty term which would deplete and/or overcompensate for an advantage that increasing the probability 2a-2f assigned to the disallowed driving maneuver 3a*-3f* would achieve with respect to the initial cost function 5.

Alternatively, or also in combination, according to block 221, a probability 2a-2f which is provided by machine learning model 1 and assigned to the disallowed driving maneuver 3a*-3f* can be set to zero prior to evaluation by the cost function 5.

Furthermore, according to block 222, the probability distribution 2 can be regularized and/or discretized so that probabilities 2a-2f below a predefined threshold are suppressed to zero.

1. A method for selecting a driving maneuver to be carried out by an at least semi-autonomously driving vehicle, comprising:
using measurement data of at least one sensor carried by the vehicle so as to create a representation of the situation the vehicle is in;
mapping the representation of the situation to a probability distribution by way of trained machine learning model, which probability distribution specifies a probability for every driving maneuver from a predefined catalog of available driving maneuvers with which said driving maneuver is carried out;
selecting a driving maneuver from the probability distribution as the driving maneuver to be carried out;
in addition to using at least one aspect of the situation the vehicle is in, determining a subset of driving maneuvers which are disallowed in this situation; and
preventing this disallowed driving maneuver from being carried out.

2. The method according to claim 1, wherein at least one disallowed driving maneuver is prevented from being carried out by setting probability in the probability distribution that this driving maneuver is carried out to zero, so that a modified probability distribution is generated.

3. The method according to claim 2, wherein the probability distribution after at least one probability is set to zero is normalized such that the remaining non-zero probabilities for driving maneuvers add up to 1, so that a modified probability distribution is generated.

4. The method according to claim 1, wherein at least one disallowed driving maneuver is prevented from being carried out by, in response to this driving maneuver being selected from the probability distribution, selecting a new driving maneuver from the probability distribution.

5. The method according to claim 1, wherein at least one disallowed driving maneuver is determined based on information retrieved from a digital location-resolved map based on the current location of the vehicle.

6. The method according to claim 1, wherein at least one disallowed driving maneuver is a driving maneuver that presents a risk of:
departing the roadway, and/or
violating general traffic rules, and/or
violating special conditions for autonomous driving operation, and/or
the ego vehicle colliding with another vehicle or other object.

7. The method according to claim 1, wherein the disallowed driving maneuvers include:
a lane change leading to departing the roadway, and/or
a lane change to a currently inaccessible lane, and/or
an acceleration and/or overtaking maneuver prohibited by traffic rules; and/or
driving behind another vehicle that is currently located behind the ego vehicle.

8. A method for training a machine learning model, which maps a representation of a situation a vehicle is in to a probability distribution which specifies, based on a predefined catalog of available driving maneuvers for each driving maneuver, a probability that this driving maneuver will be carried out, comprising:
providing learning representations of situations and associated target probability distributions to which the machine learning model is intended to map these learning representations;
entering the learning representations into the machine learning model and mapping from the machine learning model to probability distributions;
evaluating the agreement between these probability distributions and the respective target probability distributions using a predefined cost function;
optimizing parameters that characterize the behavior of the machine learning model, with the goal that further processing of learning representations will result in a better evaluation by the cost function,
wherein, regarding at least one driving maneuver disallowed in the situation characterized by the learning representation, the possibility that an increase in the probability assigned to this driving maneuver will lead to a better evaluation by the cost function is prevented.

9. The method according to claim 8, wherein the cost function is extended by a penalty term that depletes and/or overcompensates for an advantage that an increase in the probability assigned to the disallowed driving maneuver would achieve with respect to the original cost function.

10. The method according to claim 8, wherein a probability assigned to the disallowed driving maneuver provided by the machine learning model is set to zero prior to being evaluated by the cost function.

11. The method according to claim 8, wherein the probability distribution is regularized and/or discretized so that probabilities below a predefined threshold are suppressed to zero.

12. A computer program, including machine-readable instructions that, when they are executed on one or more computers, prompt the computer or computers to carry out a method according to claim 1.

13. A machine-readable storage medium and/or download product including the computer program according to claim 12.

14. A computer including the computer program according to claim 12.

15. A computer including the machine-readable storage medium and/or download product according to claim 13.

16. A computer, comprising:
the computer program according to claim 12; and
the machine-readable storage medium and/or download product according to claim 13.
